(19) United States
(12) Patent Application Publication
(10) Pub. No.: US 2007/0289541 A1
(43) Pub. Date: Dec. 20, 2007

(54) Pet toilet system

(76) Inventor: Lawrence P. Giardina, Staten Island, NY (US)

Correspondence Address: DAVIDSON, DAVIDSON & KAPPEL, LLC, 485 SEVENTH AVENUE, 14TH FLOOR, NEW YORK, NY, 10018, US

(21) Appl. No.: 11/454,523

(22) Filed: Jun. 16, 2006

(51) Int. Cl. A01K 29/00

(52) U.S. Cl. 119/165

(57) ABSTRACT

In certain embodiments, the present invention is directed to a pet toilet system comprising concave base to receive pet excrement; a drain assembly located within the base; a base dispensing pipe located on at least a portion of the perimeter of the base, the base pipe having a plurality of holes to permit the flow of water into the base; a water supply pipe connected to the base dispensing pipe, and an activator connected to the water supply pipe for charging the system with water upon activation, wherein upon activation, substantially all of the surface of the system contacted with pet excrement is contacted with water.

The present invention is directed to a pet toilet system which is suitable for indoor or outdoor use.

### BACKGROUND OF THE INVENTION

Accompanying the companionship that comes with pet ownership is the responsibility of taking care of the health and well being of the animal and maintaining clean and healthy living conditions for the pet and for the individual or group of individuals who live with the pet.

One of the major responsibilities is the disposal of body wastes excreted by the animal. The animals are typically taken outside for them to excrete their wastes and this is associated with problems.

One problem is that any owner who has the slightest bit of courtesy for his neighbours has the unpleasant task of having to physically remove the waste from the outside surface. Obviously this is practically impossible with urine and contributes to unsanitary, unhealthy living conditions.

Another problem is that the animal must be taken out multiple times daily and this is a problem for those who have busy lifestyles due to work or other responsibilities. This often results in the pet relieving themselves in the house which can damage property (e.g., rugs) and contribute to a noisome environment.

U.S. Pat. No. 3,964,437 to Brown describes a pet toilet which attempts to deal with the above issues. However, the device described therein does not rinse urine from the system in an attempt to provide an “attractant” to the animals to use the device. This is unsuitable to be used in or around a home due to the obnoxious and offensive smell which would permeate the indoor and outdoor living spaces of the occupants.

There continues to exist a need in the art to provide a system which eliminates the need for pet owners to “walk” their pets and clean up after them and which results in a clean environment for the pet owners.

### OBJECTS AND SUMMARY OF THE INVENTION

It is an object of the present invention to provide a pet toilet system which can be utilized indoors or outdoors.

It is an object of certain embodiments of the invention to provide a pet toilet system which allows for a pet to be trained to use the system to eliminate its bodily wastes, and allow the owner to simply “flush” away the waste into a household sanitary sewer system.

It is an object of certain embodiments of the present invention to provide a pet toilet system which can be used in the new construction of homes (e.g., in the corner of the garage, preferably in the furthest corner away from the overhead garage door and/or the house entry door).

It is an object of certain embodiments of the present invention to provide a pet toilet system which can be used outside of the home in a pet “run”.

It is an object of certain embodiments of the present invention to provide a pet toilet system which can be used in multiple dwellings as a common pet toilet.

It is an object of certain embodiments of the present invention to provide a pet toilet system which can be retrofitted into existing homes or wherever a water line and a sanitary waste line are nearby.

It is an object of certain embodiments of the present invention to provide a pet toilet system which is inexpensive to manufacture and which is capable of being mass produced.

It is an object of certain embodiments of the present invention to provide a pet toilet system which is can be easily installed.

The above objects and other, are met by the present invention which in certain embodiments is directed to a pet toilet system comprising a concave base to receive pet excrement; a drain assembly located within the base; a base dispensing pipe located on at least a portion of the perimeter of the base, the base pipe having a plurality of holes to permit the flow of water into the base; a water supply pipe connected to the base dispensing pipe, and an activator connected to the water supply pipe for charging the system with water upon activation, wherein upon activation, substantially all of the surface of the system contacted with pet excrement is contacted with water.

In certain embodiments, the pet toilet system comprises a vertical wall for a urinating surface connected to the base; a vertical pipe connecting the water supply pipe to a wall dispensing pipe; the wall dispensing pipe located on the wall at a point higher than the urinating surface, the wall pipe having a plurality of holes to permit the cascade of water onto the wall upon activation.

In certain embodiments, the pet toilet system comprising a concave base to receive pet excrement; a drain assembly located within the base; a base dispensing pipe located along the perimeter of the base, the base pipe having a plurality of holes to permit the flow of water into the base; a water supply pipe connected to the base dispensing pipe, and an activator connected to the water supply pipe for charging the system with water upon activation, wherein upon activation, substantially all of the surface of the system contacted with pet excrement is contacted with water.

In certain embodiments, the plurality of holes on the base dispensing pipe are located about 140 degrees to about 180 degrees from the top of the pipe.

In certain embodiments, at least a portion of the plurality of holes on the base dispensing pipe are angled to create a whirlpool effect.

In certain embodiments, th pet toilet system comprising at least one vertical wall for a urinating surface connected to the base; a vertical pipe connecting the water supply pipe to a wall dispensing pipe; the wall dispensing pipe located on each wall at a point higher than the urinating surface, the wall pipe having a plurality of holes to permit the cascade of water onto the wall upon activation.

In certain embodiments, the pet toilet system comprises a concave base to receive pet excrement; a drain assembly located within the base; a base dispensing pipe located along the perimeter of the base, the base pipe having a plurality of holes to permit the flow of water into the base, the plurality of holes on the base dispensing pipe are located about 140 degrees to about 180 degrees from the top of the pipe and being angled to create a whirlpool effect; a water supply pipe connected to the base dispensing pipe, at least one vertical wall for a urinating surface connected to the base; a vertical pipe connecting the water supply pipe to a wall dispensing pipe; the wall dispensing pipe located on each wall at a point higher than the urinating surface, the wall pipe having a plurality of holes to permit the cascade of water onto the wall; and an activator connected to the water supply pipe for charging the system with water upon activation, wherein upon activation, substantially all of the surface of the system contacted with pet excrement is contacted with water.

### BRIEF DESCRIPTION OF THE DRAWINGS

FIG. 1 is a view of a pet toilet system of the present invention.

FIG. 2 is an alternative view of a pet toilet system of the present invention

FIG. 3 is a view of a flushometer with a plunger in the out position.

FIG. 4 is a view of a flushometer with a plunger in the in position.

FIG. 5 is an elevation view of the pet toilet system.

FIG. 6 is a bottom view of the pet toilet system.

### DETAILED DESCRIPTION OF THE INVENTION

The drawings disclose a preferred embodiment of the present invention. While the embodiment illustrated is preferred, it is envisioned that various modifications of the present invention may be adopted without deviating from the invention as disclosed.

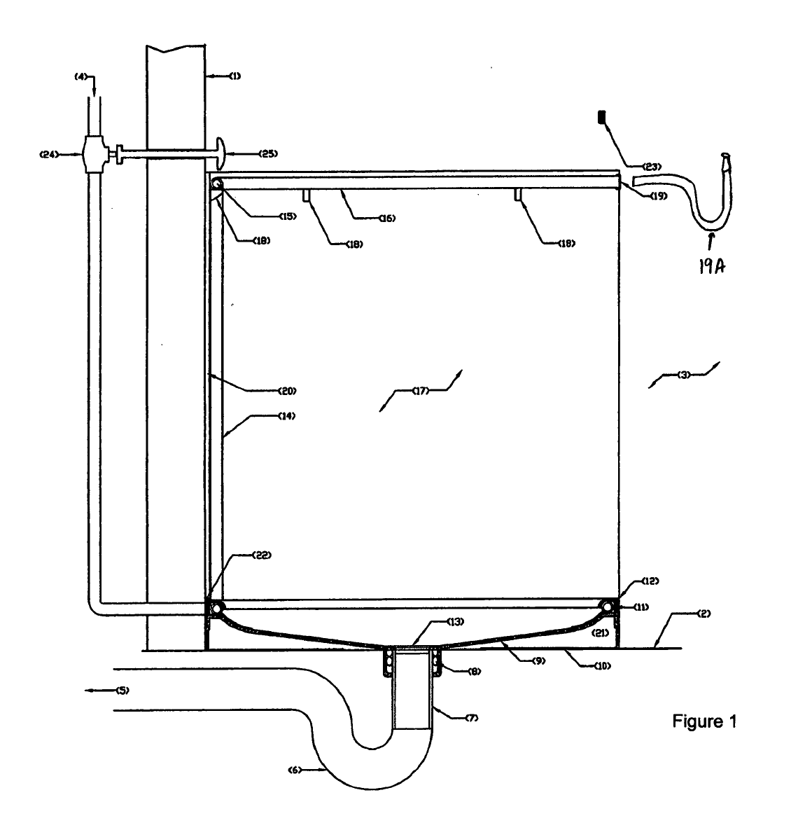

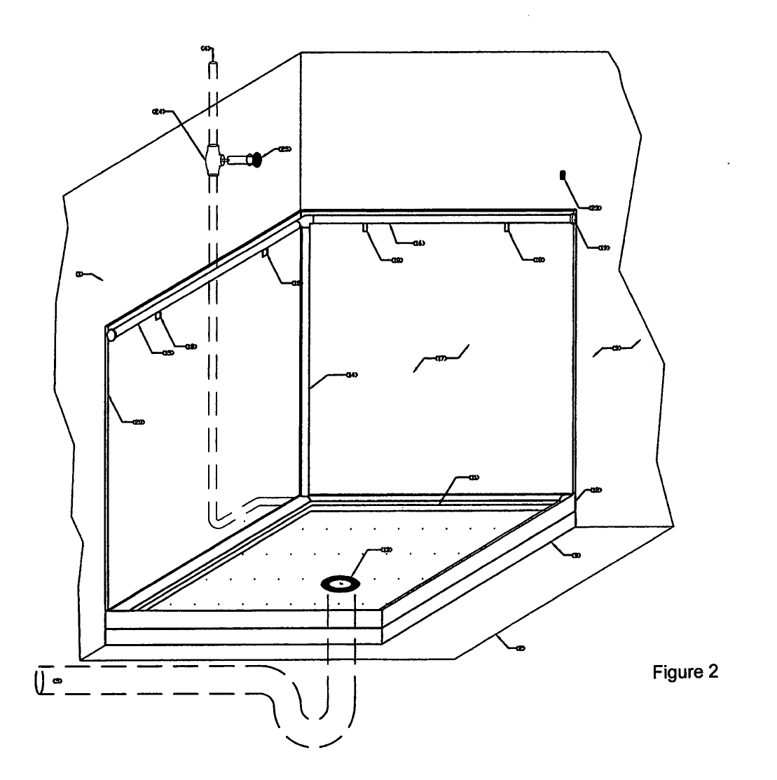

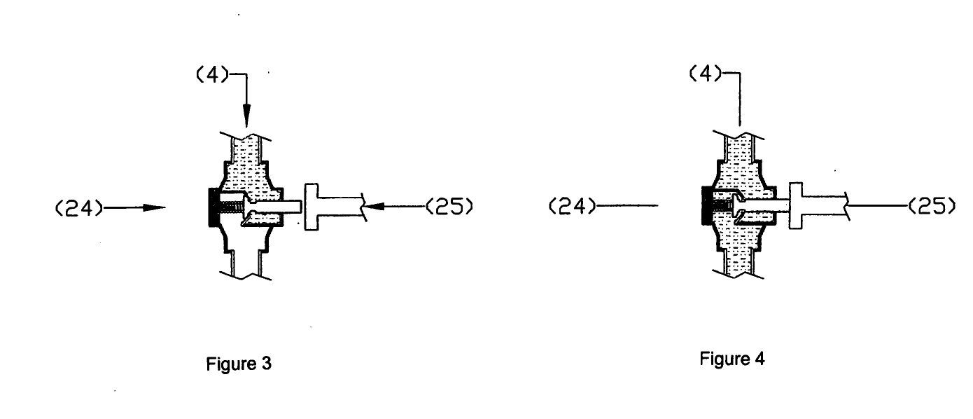

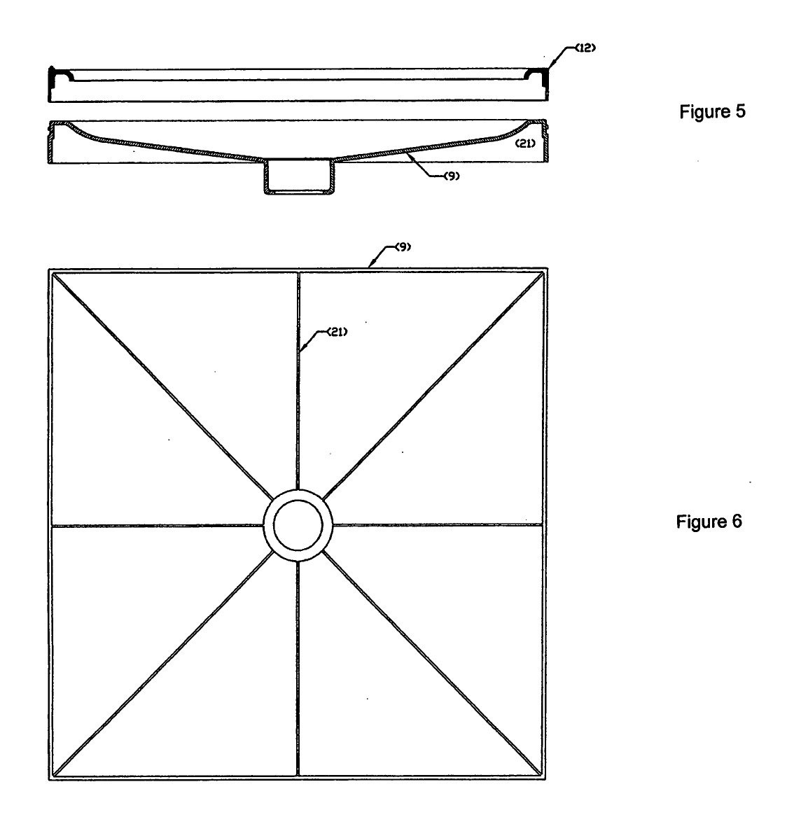

Referring to FIGS. 1-6, in certain embodiments, the pet toilet system of the present invention comprises a base (9), an optional molding surrounding the perimeter of the base (12), and wall panels (17) and (20). In certain embodiments, the wall panels are made of a lightweight material such as plastic or fiberglass. In a preferred embodiment, the walls can be made of PVC. The walls can be any thickness, but are preferably about ⅜ inch thick in order to be aesthetically pleasing when installed against an existing wall (1). The unit can be installed solely against the existing wall or against the existing wall and a perpendicular wall (3).

The base (9) and the molding (12) can be in the form of any shape, such as circular, rectangular, square or elliptical. The base can have three sides (i.e., in the form of a triangle), four sides, or more. The size of the base and molding should be of sufficient size to allow an animal to easily fit into the system. In a preferred embodiment, the base and molding form a square which can be about 30 inches to about 48 inches, preferably about 36 inches. In certain embodiments the height of the base and molding is about 1 inch to about 5 inches, preferably about 3 inches from the floor surface (2). The base should be concave in order to allow for the downward flow of water and excrement. The base can be any material (e.g., metal, plastic, or fiberglass), and can have a support (21) cast within or below the base. The support can be radial vertical web stiffener.

The wall panels (necessary for male dogs) should be a height which is sufficient to provide a suitable area for urination and depends on the size of the animal. Typically, a wall between 24 inches and 36 inches high is sufficient for most animals which would be using the system. In certain embodiments, the walls have a groove (22) which fits within the molding (12) of the base. In certain embodiments, the walls will be manufactured in order to “snap” into place and can connect to the base into a pre-molded “J” track. The walls and base can be affixed to an existing wall or floor by any suitable means such as by a fastener (e.g., one or more screws) or by an adhesive (10) (e.g., an epoxy, or bonding).

In the corner where the two wall panels meet the base unit there can be a connection (e.g., by tubing or a compression fitting) wherein once the wall panels are used and fitted into the base molded “J” track, the water supply that runs along the perimeter of the base unit will also supply the water to the top of each wall panel, through the vertical water pipe (14) allowing for it to cascade (in a waterfalls method) downward into the base unit from wall dispensing pipes (15, 16) that branch (e.g., “T” ed) off the vertical water pipe along the walls. In preferred embodiments, the wall dispensing pipes (15, 16) are perpendicular to each other and about 90 degrees from the vertical pipe. The wall dispensing pipes (15, 16) can have endcaps (19) or can have a hose attachment (19a) to assist the owner in cleaning the system. The hose attachment can be hung on a hook (23) or other fastening means on the wall.

The wall panels are for male dogs and will be cleaned each time the pet toilet system is actuated. Female dogs do not need the panels and the water supply will not be “T”ed or diverted up through the vertical water pipe (14). The corner connection and the panels are options to the base unit for either owners with male dogs or if the owner would like just a finished look to the unit. In the event that the unit is installed against one wall, it is preferable that the unit has three walls, to form a “U”. In alternative embodiments, there can be one wall panel which can be curved to give the desired shape when installed in a corner or against one wall.

The wall panels (17) and (20) can have molding rounded edges (e.g., approximately 1″ corner round), on the two external sides and on both panel tops. The wall panels can optionally have support beams (18) (e.g. a pipe) cast within or on the back of the wall panels The drain assembly (13, 8, 7, 6, and 5), is centered on the base (9) and the molding (12). A fitted, perforated, metal drain ring cover (13) can be placed over the drain to prevent pets from stepping into the drain opening, (similar to the way a manhole cover, covers over a manhole). The drain can include one or more “O” rings (8) of any suitable size, e.g., ⅝ inch with a 3 inch internal diameter. Alternatively, the drain cover can be hinged on one side and operated by a pedal built in between the base unit (9) and the molding (12). This will allow the owner to step on the pedal and open the cover and press on the water plunger (25) to supply water to the base unit at the same time.

The drain can have a “trap” design (6), whereby water from the last usage will trap any gases that may emanate from the sewer system back into the area that the pet toilet system is installed. A further pipe (7) connects the drain to the trap and the trap exits to a sewer line (5) which can run to a municipal sewer system or to a septic tank.

The flushometer (24), which can be designed behind the existing wall (1) or (3), will charge the water line (4) (behind the wall), upon pushing the plunger (25) “in” (towards the wall). Water will then flow through the “T”-ed connection and circulate all along the base from the base dispensing pipe (11). When the owner removes the hand-applied pressure from the plunger, the flushometer value shuts off and the remaining water in the base dispensing pipe (11), drains through the holes around the perimeter of the base. In outdoors use, this design is critical to prevent frost problems (i.e.: the water will expand when freezing) and as long as there are holes along the perimeter of the base dispensing pipe (11), the water will move out from the holes and not freeze. Although a flushometer and plunger is depicted in the figures, any mechanism capable of actuating the system can be utilized.

The water supply coming from the home's plumbing, and which is normally above the ceiling height to avoid interference with doors and windows of the garage walls, can be fitted with the flushometer (24) which can be activated by pushing the plunger to operate the valve (25) located in the wall, (the water line and the valve itself will be located behind the wall). This “spring activated” valve will not charge the water line (4) to the base, until the plunger is pushed in. Once pressure is applied to the plunger, the valve is opened and the water is supplied through the water pipe (4) to the perimeter of the base through the base dispensing pipe (11), which has pre-drilled, angled holes.

The holes can be ⅛″ holes and drilled approximately every 1″ in the base dispensing pipe (11), all along the four equal lengths, constituting the perimeter, and are alternately angled to one side and downward, to create an alternating whirlpool and a pushing effect, so that the water gently moves the pet's waste (liquid and solid), to the center drain.

In outside use, the actual location of the hole can be 165 to 180 degrees from the top of the pipe in the (11) base unit. The reason for this location of the holes is more appropriate for the outside use of this product, whereby freezing is a concern. This location will allow water to drain from the pipe perimeter once the water supply is turned off.

1. A pet toilet system comprising:
a concave base to receive pet excrement;
a drain assembly located within the base;
a base dispensing pipe located on at least a portion of the perimeter of the base, the base dispending pipe having a plurality of holes to permit the flow of water into the base;
a water supply pipe connected to the base water dispensing pipe, and
an activator connected to the water supply pipe for charging the system with water upon activation, wherein at least a portion of the plurality of holes on the base dispensing pipe are angled to create a whirlpool effect, whereby upon activation, substantially all of the surface of the system contacted with pet excrement is contacted with water and wherein the plurality of holes on the base dispensing pipe are arranged such that the remaining water in the base dispensing pipe drains through the holes around the perimeter of the base to prevent frost problems when used outdoors.

2. The pet toilet of claim 1, further comprising:
a vertical wall for a urinating surface connected to the base;
a vertical pipe connecting the water supply pipe to a wall water dispensing pipe;
the wall water dispensing pipe located on the wall at a point higher than the urinating surface, the wall dispensing pipe having a plurality of holes to permit the cascade of water onto the wall upon activation.

3. The pet toilet of claim 1, wherein the concave base has at least three sides.

4. The pet toilet of claim 1, wherein the base dispensing pipe is located on at least two of the sides.

5. The pet toilet of claim 3, comprising a wall on at least two of the sides of the base.

6. The pet toilet of claim 5, comprising a wall dispensing pipe located on each wall.

7. The pet toilet of claim 1, wherein the activator is a flushometer.

8. The pet toilet system of claim 1, wherein the plurality of holes on the base dispensing pipe are located about 140 degrees to about 180 degrees from the top of the pipe.

9. (canceled)

10. The pet toilet system of claim 1, wherein the drain assembly is connected to a sewer line.

11. The pet toilet system of claim 1, wherein the drain assembly is connected to a septic tank.

12. The pet toilet system of claim 1, wherein the base pipes, wall pipes and vertical pipes comprise a plastic material.

13. The pet toilet system of claim 7, wherein the flushometer is located behind a wall.

14. The pet toilet system of claim 13, wherein the flushometer is activated by a plunger located on the opposite side of the wall.

15. A pet toilet system comprising:
a concave base to receive pet excrement;
a drain assembly located within the base;
a base dispensing pipe located along the perimeter of the base, the base pipe having a plurality of holes to permit the flow of water into the base;
a water supply pipe connected to the base dispensing pipe, and
an activator connected to the water supply pipe for charging the system with water upon activation, wherein at least a portion of the plurality of holes on the vertical base water dispensing pipe are angled to create a whirlpool effect, whereby upon activation, substantially all of the surface of the system contacted with pet excrement is contacted with water and wherein the plurality of holes on the base dispensing pipe are arranged such that the remaining water in the base dispensing pipe drains through the holes around the perimeter of the base to prevent frost problems when used outdoors.

16. The pet toilet system of claim 15, wherein the plurality of holes on the base dispensing pipe are located about 140 degrees to about 180 degrees from the top of the pipe.

17. The pet toilet system of claim 15, wherein at least a portion of the plurality of holes on the base dispensing pipe are angled to create a whirlpool effect.

18. The pet toilet system of claim 15, further comprising at least one vertical wall for a
urinating surface connected to the base;
a vertical pipe connecting the water supply pipe to a wall dispensing pipe;
the wall dispensing pipe located on each wall at a point higher than the urinating surface,
the wall pipe having a plurality of holes to permit the cascade of water onto the wall upon activation.

19. The pet toilet of claim 15, wherein the activator is a flushometer.

20. A pet toilet system comprising:
a concave base to receive pet excrement;
a drain assembly located within the base;
a base dispensing pipe located along the perimeter of the base, the base pipe having a plurality of holes to permit the flow of water into the base, the plurality of holes on the base dispensing pipe are located about 140 degrees to about 180 degrees from the top of the pipe and being angled to create a whirlpool effect;
a water supply pipe connected to the base dispensing pipe,
at least one vertical wall for a urinating surface connected to the base;
a vertical pipe connecting the water supply pipe to a wall dispensing pipe;
the wall dispensing pipe located on each wall at a point higher than the urinating surface, the wall pipe having a plurality of holes to permit the cascade of water onto the wall; and
an activator connected to the water supply pipe for charging the system with water upon activation, wherein upon activation, substantially all of the surface of the system contacted with pet excrement is contacted with water and wherein the plurality of holes on the base dispensing pipe are arranged such that the remaining water in the base dispensing pipe drains through the holes around the perimeter of the base to prevent frost problems when used outdoors. .
